(19) United States
(12) Patent Application Publication
(10) Pub. No.: US 2005/0164736 A1
(43) Pub. Date: Jul. 28, 2005

(54) DEVICE FOR CONVERTING A CORDED TELEPHONE HANDSET TO CORDLESS

(76) Inventor: Richard G. Brull, North Kansas City, MO (US)

Correspondence Address: HOVEY WILLIAMS LLP, 2405 GRAND BLVD., SUITE 400, KANSAS CITY, MO, 64108, US

(21) Appl. No.: 10/905,631

(22) Filed: Jan. 13, 2005

Related U.S. Application Data
(60) Provisional application No. 60/537,242, filed on Jan. 16, 2004.

(51) Int. Cl. H04M 1/00

(52) U.S. Cl. 455/557

(57) ABSTRACT

A device for converting a corded telephone handset to cordless is disclosed. A base transceiver unit (14) connects to a standard, pre-existing connector of a base portion (16) of a telephone (12) and a handset transceiver unit (18) connects to a standard, pre-existing connector of a handset portion (20) of the telephone (12). A first wireless transceiver (24) in the base transceiver unit (14) communicates with a second wireless transceiver (34) in the handset transceiver unit (18), thus enabling wireless communications between the handset portion (20) and the base portion (16).

### RELATED APPLICATION

The present application is a nonprovisional patent application and claims priority benefit, with regard to all common subject matter, of earlier-filed, U.S. provisional patent application titled “DEVICE FOR CONVERTING TELEPHONE HANDSET TO CORDLESS,” Ser. No. 60/5 37,242, filed Jan. 16, 2004. The identified earlier-filed provisional application is hereby incorporated by reference into the present application.

### BACKGROUND OF THE INVENTION

1. Field of the Invention

The present invention relates to a device for converting a corded telephone handset to a cordless telephone handset. More particularly, the present invention provides a first wireless transceiver for connecting to a telephone handset and a second wireless transceiver for connecting to a telephone base, wherein telephone audio signals are communicated between the base and the handset via the wireless transceivers.

2. Description of Prior Art

Telephone systems are an integral and indispensable tool in modern businesses and homes. Telephone users increasingly expect more from their telephone systems. Modern office telephone systems, for example, typically include such functions as inter-office call transferring, call holding, teleconferencing, voicemail, paging, and rapid inter-office dialing. FIG. 1 illustrates a typical prior art telephone for use in an office telephone system, wherein the telephone includes a base and a handset interconnected by a telephone cord, wherein the cord provides wired electrical communications between the telephone base and the telephone handset.

While the traditional telephone shown in FIG. 1 is sufficient in some circumstances, it suffers from certain problems and limitations. Because the handset and the base are interconnected by the cord, for example, a telephone user's physical movement is limited when using the phone. If the user needs to access a document or other item beyond the user's reach while speaking on the phone, the user must stretch the handset cord, move the base portion of the phone, and/or abandon the handset portion of the phone while retrieving the document. It will be appreciated that each of these actions may be undesirable. Stretching the handset cord, for example, can result in inadvertent movement of the base portion, possibly causing the base portion to fall off a desk or other surface, and may cause the cord to collide with other items on the desk. Moving the base portion of the phone may also cause a cord connecting the base portion to a wall phone jack to collide with items on a desk and otherwise obstruct use of the desk. Finally, abandoning the handset portion to retrieve the document is undesirable because it requires the user to stop conversing with the other party, which results in a waste of both parties' time, appears unprofessional, and may even offend the other party.

One solution to this problem is to use a cordless telephone. Cordless telephones are known in the art and include a base portion and a handset portion that are adapted to communicate wirelessly as opposed to using a cord. Such telephones allow a user to move freely within a vicinity of the base portion while holding the handset portion without the problems created by a cord described above. Unfortunately, use of these cordless telephones suffers from certain problems and limitations. Existing office telephone systems, for example, may rely on a particular type of phone that includes a cord. Interchanging the corded phone with a cordless phone is not feasible because a cordless telephone would be incompatible with the office telephone system. Furthermore, even if it were feasible to exchange a corded telephone with a cordless telephone, a user may choose not to make the change if, for example, the change would be too expensive or the user could not find a satisfactory cordless telephone.

Thus, there exists a need in the art for an improved telephone system that does not inhibit a user's movement while using the telephone.

### SUMMARY OF THE INVENTION

The present invention provides an improved device for wirelessly connecting a telephone base with a telephone handset that does not suffer from the problems and limitations of the prior art describe above. Particularly, the present invention provides a device that allows a user to convert an existing telephone with a corded handset into a telephone with a cordless handset using the existing telephone base and handset, thus eliminating the need for a cord or an entirely new phone. In one embodiment of the invention, the device comprises a first transceiver for removably connecting to the base and for enabling the base to wirelessly communicate with the interface, and a second transceiver for enabling the interface to wirelessly communicate with the base.

In another embodiment, the first transceiver includes a housing that presents a connector adapted to electrically couple the transceiver to the base and to support the transceiver in a fixed position relative to the base. The second transceiver also includes a housing that presents a connector adapted to electrically couple the second transceiver to the interface and to support the transceiver in a fixed position relative to the interface.

In yet another embodiment, the base transceiver unit includes a first wireless transceiver for receiving incoming signals from the telephone base and wirelessly transmitting the incoming signals, and for wirelessly receiving outgoing signals and communicating the outgoing signals to the telephone base; a first cord for removably coupling the transceiver to a standard connector of the base of the telephone; and a housing for containing the transceiver and for securing to the base of the telephone.

The handset transceiver unit includes a second wireless transceiver for receiving wireless incoming signals from the first wireless transceiver and communicating the incoming signals to a speaker of the handset, and for receiving outgoing signals from a microphone of the handset and wirelessly transmitting the outgoing signals to the first wireless transceiver; a second cord for removably coupling the transceiver to a standard connector of the telephone handset; and a housing for containing the transceiver and for securing to the handset of the telephone.

Other aspects and advantages of the present invention will be apparent from the following detailed description of the preferred embodiments and the accompanying drawing figures.

### BRIEF DESCRIPTION OF THE DRAWINGS

Preferred embodiments of the invention are described in detail below with reference to the attached drawing figures, wherein:

FIG. 1 is a perspective view of a conventional prior art telephone having a base and a handset connected by a cord;

FIG. 2 is a perspective view of a device for converting a corded telephone handset to a cordless handset constructed in accordance with a preferred embodiment of the invention and shown in use with the telephone of FIG. 1;

FIG. 3 is a block diagram of components of a base transceiver unit of the device of FIG. 2;

FIG. 4 is a block diagram of components of an interface transceiver unit of the device of FIG. 2;

FIG. 5 is a perspective view of a device for replacing a corded telephone handset with a cordless handset constructed in accordance with an alternative embodiment of the invention and shown in use with the telephone of FIG. 1; and

FIG. 6 is a perspective view of alternative embodiments of the invention, wherein the interface transceiver unit of FIG. 2 is used with a headset.

### DETAILED DESCRIPTION OF PREFERRED EMBODIMENTS

Referring initially to FIG. 2, an exemplary device for converting a corded telephone handset to a cordless handset employing the principles of the present invention is shown in use with a standard telephone and designated generally by the reference numeral 10. The device 10 broadly includes a base transceiver unit 14 adapted to connect to a telephone base 16, and an interface transceiver unit 18 adapted to connect to a telephone handset 20.

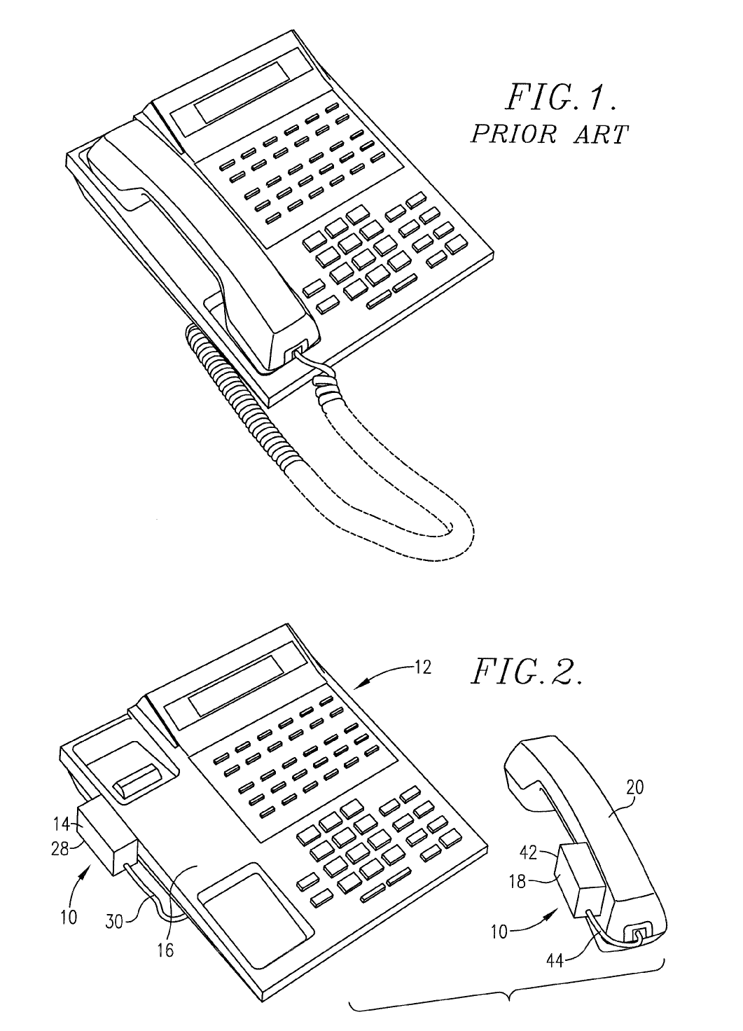

The telephone 12 is a standard telephone that provides a wired electrical interconnection between the base 16 and the handset 20. The illustrated telephone 12 exhibits a form and function common to office telephones that are used as part of an office telephone system. The telephone handset 20 provides a telephone interface and is a standard telephone handset including a microphone and a speaker separated by a handle portion. As explained below, however, the device 10 may be used with a variety of interface devices and is not restricted to use with telephones that employ the illustrated handset 20. The base 16 of the telephone 12 includes a female RJ22 connector (not shown) adapted to receive a male RJ22 connector of a first end of a cord (see FIG. 1). The interface 20 also includes a female RJ22 connector adapted to receive a male RJ22 connector of a second end of the cord.

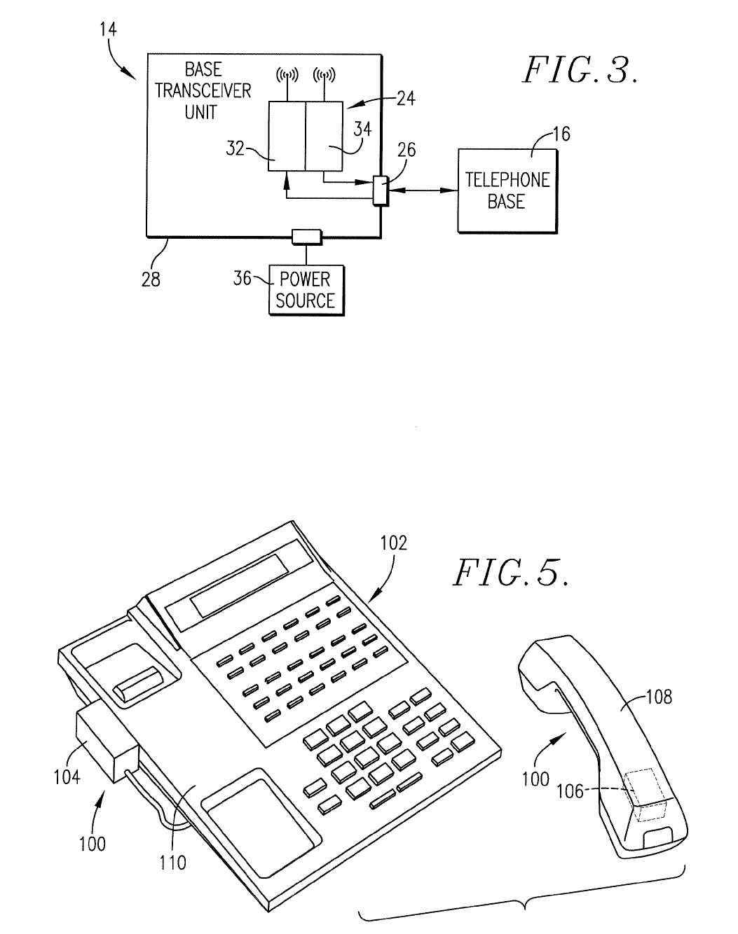

The base transceiver unit 14 generally allows the telephone base 16 to communicate wirelessly with the interface 20. Referring also to FIG. 3, the illustrated base transceiver unit 14 comprises a first wireless transceiver 24, a first communications connector 26, and a base transceiver unit housing 28. The first wireless transceiver 24 communicates with the base 16 of the telephone 12 via the first connector 26. The connector 26 mates with the female RJ22 connector of the base portion 16 of the telephone, and is thus preferably a male RJ22 connector. The connector 26 may be attached to the housing 28 via a short cord 30, as illustrated in FIG. 2. Alternatively, the connector 26 may be attached directly to the housing 28 or may be integral with the housing 28 if, for example, the entire base transceiver unit 14 is designed to removably “snap on” to, and be supported by, the female RJ22 connector of the telephone base portion 16 to facilitate removal of the device 10 from the telephone 12.

The first wireless transceiver 24 receives incoming telephone signals from the base 16 of the telephone 12 and transmits the incoming signals in wireless form to be received by the interface transceiver unit 18. The transceiver 24 also receives outgoing signals communicated wirelessly by the interface transceiver unit 18, converts the wireless signals into outgoing telephone signals, and communicates the outgoing telephone signals to the base 16 of the telephone 12.

The first wireless transceiver 24 broadly comprises a transmit portion 32 and a receive portion 34. The transmit portion 32 receives the incoming telephone signals from the telephone base 16 and wirelessly transmits the incoming signals to the interface transceiver unit 18, while the receive portion 34 receives the outgoing wireless signals from the interface transceiver unit 18 and communicates the outgoing signals to the telephone base 16 in the form of outgoing telephone signals. The transmit portion 32 and the receive portion 34 may be separate transmitter and receiver integrated circuits, respectively, such as an ES series RF transmitter and an ES series RF receiver manufactured by LINX TECHNOLOGIES™. Alternatively, the transceiver 24 may include a transmitter and a receiver produced as a single integrated circuit; or may be constructed substantially entirely of discreet electrical components.

The base transceiver unit housing 28 is adapted to enclose and contain other components of the base transceiver unit 14, such as the transceiver 24 and various electrical interconnections, so as to protect and shield them from the hazards of use (e.g., jostling, dropping, other mechanical shock) and of the environment (e.g., dust, moisture). As such, the housing 28 is preferably constructed from a suitable lightweight and impact-resistant material such as, for example, plastic, nylon, aluminum, or any combination thereof. Additionally, the housing 28 preferably includes one or more appropriate gaskets or seals to make it substantially waterproof or resistant. Though shown as being substantially rectangular, the housing 28 may take any suitable shape, including, for example, shapes molded to substantially correspond to a portion of the base portion 16 of the telephone 12 whereupon or against which the housing 28 is meant to rest.

As illustrated in FIG. 2, the housing 28 is preferably removably or fixedly secured to the base 16. Because the base 16 will generally remain stationary during use, however, the housing 28 need not be secured to the base 16 at all, but may simply be placed close enough to the base 16 to allow the communications connector 26 to connect thereto.

The base transceiver unit 14 is energized by power source 36. Because the telephone base 16 will typically remain stationary during use of the telephone 12, the power source 36 preferably is external to the unit 14 and draws power from a standard electrical power outlet to obviate the need to replace or recharge batteries. Alternatively, the power source 36 may draw power directly from a telephone line. The latter alternative would eliminate the need for power cords connecting the base transceiver unit 14 to an electrical outlet, thus enabling a user to implement the unit 14 wherever the telephone 12 may be attached to a telephone line regardless of whether it is in the vicinity of an electrical outlet.

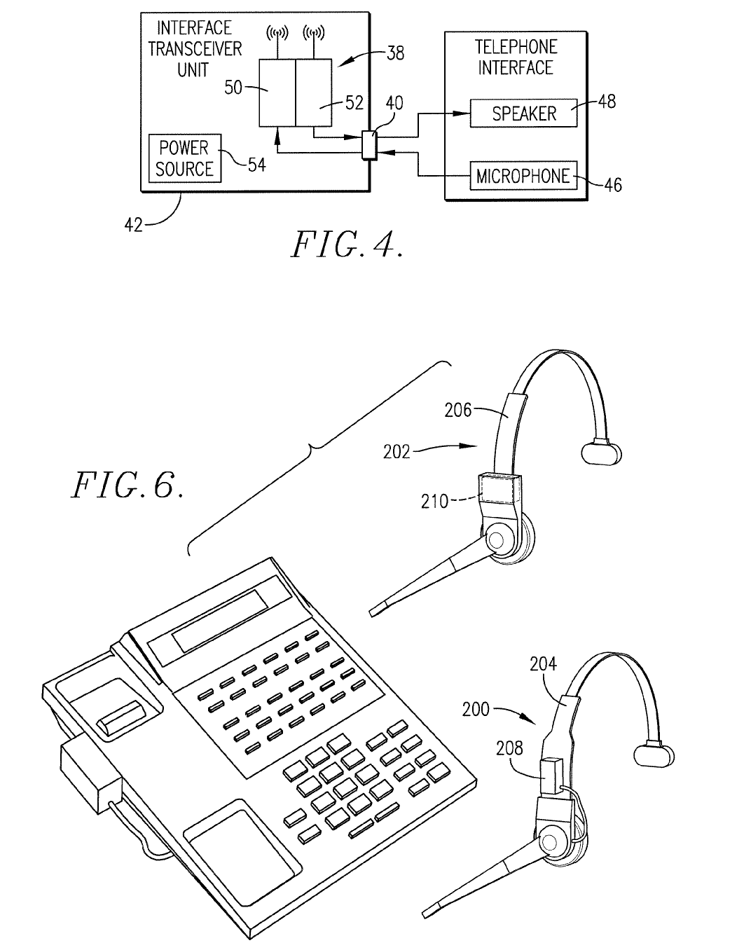

The interface transceiver unit 18 generally allows the telephone handset 20 to communicate wirelessly with the telephone base 16. Referring also to FIG. 4, the illustrated interface transceiver unit 18 comprises a second wireless transceiver 38, a second communications connector 40, and an interface transceiver unit housing 42. The second wireless transceiver 38 receives telephone audio signals from the telephone handset 20 via the connector 40. The connector 40 mates with the female RJ22 connector of the telephone handset portion 20, and is thus preferably a male RJ22 connector. The connector 40 may be attached to the housing 42 via a short cord 44, as illustrated in FIG. 2. Alternatively, the connector 40 may be attached directly to the housing 42 or may be integral with the housing 42 if, for example, the entire handset transceiver unit 18 is designed to removably “snap on” to, and be supported by, the female RJ22 connector of the telephone handset portion 20 to facilitate removal of the device 10 from the telephone 12.

The second wireless transceiver 38 receives telephone audio signals from the microphone 46 of the telephone handset 20 and transmits the audio signals in wireless form to be received by the base transceiver unit 14. The transceiver 38 also receives wireless signals communicated by the base transceiver unit 14, converts the wireless signals into telephone audio signals, and communicates the telephone audio signals to the speaker 48 of the telephone handset 20.

The second wireless transceiver 38 comprises a transmit portion 50 and a receive portion 52, and is substantially identical to the first wireless transceiver 24 in form and function and therefore will not be discussed in detail. The interface transceiver unit housing 42 is likewise similar in form and function to the base transceiver unit housing 28, with the exception that the interface transceiver unit housing 42 is adapted to be secured to the telephone handset 20 instead of the telephone base 16.

The interface transceiver unit 18 is powered by power source 54. Because the handset 20 is adapted to be moved during use, the power source 54 is preferably a rechargeable battery or other portable power source adapted to be secured to or stored within the interface transceiver unit housing 42.

In use, a user first removes a cord interconnecting the telephone base 16 with the telephone handset 20 by uncipping the male RJ22 connectors on each end of the cord from the female RJ22 connectors on the base 16 and the handset 20. The housing 28 of the base transceiver unit 14 is then secured to the telephone base 16 by, for example, bonding the housing 28 to the base 16 with an adhesive or adhesive tape. The base transceiver unit 14 is then electrically connected to the telephone base 16 by snapping the male RJ22 connector of the connector 26 of the base transceiver unit 14 into the female RJ22 connector of the base 16. The interface transceiver unit 18 is similarly secured to an outer surface of the telephone handset 20, and electrically connected to the handset 20 via connector 40. With the base transceiver unit 14 and the interface transceiver unit 18 installed, the user can use the telephone 12 in the usual manner. It will be appreciated, however, that the limitations associated with a corded handset are eliminated by use of the device 10 and that the user is free to move about uninhibited by a telephone cord.

Turning now to FIG. 5, an exemplary device for replacing a corded telephone handset with a cordless handset employing the principles of a second embodiment of the present invention is shown in use with a standard telephone and designated generally by the reference numeral 100. The device 100 is adapted for use with a standard telephone 102 and includes a base transceiver unit 104 substantially identical to the base transceiver unit 14 of the device 10 described above. The device 100 also includes an interface transceiver unit 106 internal to a telephone handset 108. The interface transceiver unit 106 is substantially identical to the interface transceiver unit 18 of the device 10 described above, except that the interface transceiver unit 106 is adapted to be manufactured internal to the telephone handset 108.

The device 100 of the second embodiment of the present invention is installed on the telephone 102 by removing an existing telephone handset from the telephone 102 along with any cord that joins the handset portion with a telephone base 110. The base transceiver unit 104 is then connected to the telephone base 110 and the custom telephone handset 108 containing the internal transceiver unit 106 is seated in a cradle of the telephone 102 for use.

The device 100 has the advantage of hiding the handset transceiver unit 106 from view and reducing the overall size of the telephone interface 108. Furthermore, a manufacturer of the device 100 may include more functions and features in the device 100 by adding the functions/features to the telephone handset portion 108.

Referring now to FIG. 6, alternative embodiments of the present invention are shown in use with a telephone and designated generally by the reference numerals 200 and 202. Each of the devices 200,202 present headsets 204 and 206, respectively, wherein the headsets include a speaker and a microphone adapted to be mounted on a user's head or other area of the user's person. Each headset 204,206 is adapted for use with a base transceiver unit substantially identical to the base transceiver unit 14 described above. Because the base transceiver unit 14 was described in detail above, only the headsets 204,206 will be discussed here. The device 200 includes a headset transceiver unit 208 adapted to connect to the telephone headset 204, wherein the transceiver unit 208 is substantially identical to the interface transceiver unit 18 of the device 10 described above, except that the interface transceiver unit 208 is adapted for use with the headset 204. Therefore, the transceiver unit 208 is external to the headset 204 and removably connects to the headset 204.

The device 202 includes a headset transceiver unit 210 that is substantially similar to the headset transceiver unit 208, except that the headset transceiver unit 210 is manufactured internal to the headset 204. The device 202 is installed on a telephone by removing an existing telephone interface, such as a handset or a headset, from the telephone along with any cord that joins the interface with a telephone base.

The preferred forms of the invention described above are to be used as illustration only, and should not be utilized in a limiting sense in interpreting the scope of the present invention. Obvious modifications of the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

1. A device for enabling wireless communications between a telephone base and a telephone interface, the device comprising:
a first transceiver for removably connecting to the base and for enabling the base to wirelessly communicate with the interface; and
a second transceiver for enabling the interface to wirelessly communicate with the base.

2. The device as set forth in claim 1, further comprising a housing for containing the first transceiver and for attaching to the base of the telephone.

3. The device as set forth in claim 1, wherein the telephone interface is a handset.

4. The device as set forth in claim 3, wherein the second transceiver removably connects to the handset.

5. The device as set forth in claim 4, further comprising a housing for containing the second transceiver and for attaching to the handset.

6. The device as set forth in claim 1, further comprising a first connector for connecting the first transceiver to a connector of the base of the telephone.

7. The device as set forth in claim 6, further comprising a second connector for connecting the second transceiver to a connector of the handset of the telephone.

8. The device as set forth in claim 7, further comprising a first cord for electrically removably coupling the first connector to the connector of the base of the telephone.

9. The device as set forth in claim 8, further comprising a second cord for electrically removably coupling the second connector to the connector of the handset of the telephone.

10. The device as set forth in claim 1, further comprising a portable power source for energizing the second transceiver.

11. The device as set forth in claim 1, wherein the second transceiver is integral with the handset of the telephone.

12. The device as set forth in claim 1, wherein the interface is a headset.

13. The device as set forth in claim 12, wherein the second transceiver is removably connected to the headset.

14. The device as set forth in claim 12, wherein the second transceiver is integral with the headset.

15. A device for enabling wireless communications between a telephone base and a telephone interface, the device comprising:
a first transceiver for enabling the base to wirelessly communicate with the interface, wherein the transceiver includes a housing that presents a connector adapted to electrically couple the transceiver to the base and to support the transceiver in a fixed position relative to the base; and
a second transceiver for enabling the interface to wirelessly communicate with the base, wherein the transceiver includes a housing that presents a connector adapted to electrically couple the transceiver to the interface and to support the transceiver in a fixed position relative to the interface.

16. The device as set forth in claim 15, wherein the interface is a standard telephone handset.

17. The device as set forth in claim 15, wherein the interface is a standard telephone headset.

18. A device for enabling wireless communicates between a telephone base and a telephone handset, the device comprising:
a base transceiver unit including
a first wireless transceiver for receiving incoming signals from the telephone base and wirelessly transmitting the incoming signals, and for wirelessly receiving outgoing signals and communicating the outgoing signals to the telephone base,
a first cord for removably coupling the transceiver to a standard connector of the base of the telephone, and
a housing for containing the transceiver and for securing to the base of the telephone; and
a handset transceiver unit including
a second wireless transceiver for receiving wireless incoming signals from the first wireless transceiver and communicating the incoming signals to a speaker of the handset, and for receiving outgoing signals from a microphone of the handset and wirelessly transmitting the outgoing signals to the first wireless transceiver,
a second cord for removably coupling the transceiver to a standard connector of the telephone handset, and
a housing for containing the transceiver and for securing to the handset of the telephone.
